(19) United States
(12) Patent Application Publication
(10) Pub. No.: US 2024/0221107 A1
(43) Pub. Date: Jul. 4, 2024

(54) APPARATUS AND METHOD FOR IMAGE DATA ACQUISITION AND PROCESSING

(71) Applicant: AKXA TECH PVT. LTD., Kolhapur (IN)

(72) Inventors: Raghuraj RAO, Kolhapur (IN); Vishwanath KESHETTY, Kolhapur (IN)

(21) Appl. No.: 18/398,308

(22) Filed: Dec. 28, 2023

(30) Foreign Application Priority Data
Dec. 29, 2022 (IN) 202221076966

(51) Int. Cl. G06T 1/00

(52) U.S. Cl. CPC G06T 1/0007; H04L 67/10

(57) ABSTRACT

Present invention relates to an apparatus for image data acquisition and processing. A graphic signal receiver unit receives graphic signal from a source machine. A grabber unit captures data images from the received graphic signals at a predefined time interval. An image processing unit processes the captured data images. The image processing unit includes processors and a computer readable medium storing instructions. The processors execute the instruction and perform the steps of: identifying, by an identification module, a numeric value present in each of the captured data images using a digit recognition technique, digitizing, by a digitizer, each of the identified numeric values with corresponding time stamps to provide digitized data files, collecting, by a recording module, the digitized data files, and communicating, by a communication module, the data files to a destination device.

### FIELD OF THE INVENTION

The present invention relates to the field of digital data processing and more particularly to an apparatus and a method for digital image data acquisition in non-invasive manner in real time.

### BACKGROUND OF THE INVENTION

With the advent of automation and control technologies, it has become desirable that display data on monitors or display devices be shared, in digitized form, with other systems in a network for real-time monitoring, record keeping and other critical analytical purposes. Digitization of display information that cannot be extracted otherwise, for example, for continuous recording of values being displayed on industrial displays for later use, and its subsequent transmission to a remote location is of great value, such as for building historians recorded data for unique management information system, analytics and graphic visualisation. It is critical for industries/plants with obsolete systems to upgrade the technology or migrate to Internet of Things (IOT). However, such upgradation or migration involves very high initial capital investment that may not be feasible for all kinds of plants. Though one way could be tweaking the existing unsecured control systems to access data. However, in the case of secured or locked distributed control systems, such invasion may not be feasible.

There is therefore an unmet need to provide a cost effective data extraction and digitization system and/or device that can be incorporated within the existing control systems for the purpose of monitoring or record keeping or other critical analytical purposes in a non-invasive manner.

### SUMMARY OF THE INVENTION

The present invention relates to the field of digital data processing. More particularly, the present invention relates to an apparatus and a method for image data acquisition and processing in non-invasive manner using a real time digitization tool.

One objective of the present invention is to provide an apparatus that is capable providing digital values from a non-invasive system, which cannot be extracted otherwise. Non-invasive systems being legacy/secure/locked systems.

Another objective of the present invention is to provide an apparatus that is capable of reading values of an industrial display for further processing or later use, without touching or interfering with the existing working of the system.

Another objective of the present invention is to provide an apparatus that facilitates transfer of data over a network to a remote location for a remote use.

Yet another objective of the present invention is to provide an apparatus that is capable of building historians with recorded data for unique or customised management information system (MIS), analytics and graphic visualization.

Another objective of the present invention is to provide an apparatus that can be incorporated within an existing industry/continuous process plants where access to secured or locked control system in distributed setting is not feasible.

Yet another objective of the present invention is to provide an apparatus that can be incorporated within a plant with old generation control system where migration to Smart 4th Gen/IoT technology is not feasible.

To achieve the above mentioned objectives of the present invention, in one embodiment of the present invention, there is provided an apparatus for image data acquisition and processing. The apparatus comprises a graphic signal receiver unit, a grabber unit, and an image processing unit. The graphic signal receiver unit is configured to receive graphic signals from at least one source display unit of a source machine. The grabber unit is configured to capture one or more data images from the received graphic signals at a predefined time interval. The image processing unit is configured to process the captured one or more data images, the image processing unit including one or more processors and a computer readable medium storing instructions.

In one embodiment of the present invention, on execution of the instructions by the one or more processors, the processor perform the steps of:
identifying, by an identification module, a numeric value present in each of the captured data images using a digit recognition technique;
digitizing, by a digitizer, each of the identified numeric values with corresponding time stamps to provide digitized data files;
collecting, by a recording module, the digitized data files: and
communicating, by a communication module, the data files to a destination device.

In another embodiment of the present invention, the apparatus comprises a signal splitter device attached between an output of the source machine and the graphic signal receiver unit. The signal splitter device is configured to split the graphic signal of the source machine to at least two signals and supplying one of the signal to the graphic signal receiver unit

In one embodiment of the present invention, the source machine is at least one of a source computer and a distributed control system (DCS) server unit.

In one embodiment of the present invention, the destination device is a computer.

In yet another embodiment of the present invention, the apparatus comprises a network based device for collection and/or transmission of the digitized data files to a destination device at a remote location at a prescribed interval

In one embodiment of the present invention, the network based device is a communicator selected from at least one of a local intranet server, a cloud resource and a mobile device.

In another aspect of the present invention is provided a method for image data acquisition and processing, the method comprises the steps of:
receiving graphic signals from a source machine;
capturing one or more data images from the received graphic signal;
identifying a numeric value present in each of the captured data images using a digit recognition technique;
digitising each of the identified numeric values with corresponding time stamps to provide digitized data files;
collecting the digitized data files: and
communicating the data files to a destination device.

In one aspect of the present invention, the method step further includes splitting the graphic signal received from the source machine into at least two signals supplying one of the signal to the graphic signal receiver unit.

In another aspect of the present invention, the method step further includes collecting data set in digitised format and transmitting the data set in digitised format to a destination device at a remote location at a prescribed interval.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram set up using the apparatus for data acquisition in accordance with the present invention.

FIG. 2 illustrates a setup work flow chart for first time run of the user interface application and configuration of the apparatus in accordance with the present invention.

FIG. 3 illustrates a usage work flow chart for subsequent run of the user interface application of the apparatus in accordance with the present invention.

FIG. 4A illustrates a user login interface for accessing the apparatus on a destination device, in accordance with the present invention.

FIG. 4B illustrates user interface of the apparatus on the destination device showing captured data from the source machine to be digitised.

FIG. 4C illustrates digitised values of the captured data from the source machine.

FIG. 4D illustrates the export of the digitised data into the digitised format.

FIG. 5 illustrates the flowchart depicting the correlation between the hardware and user interface aspect of the present user interface working in coordination with one another, in an aspect of the present invention.

### DETAILED DESCRIPTION OF THE INVENTION

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

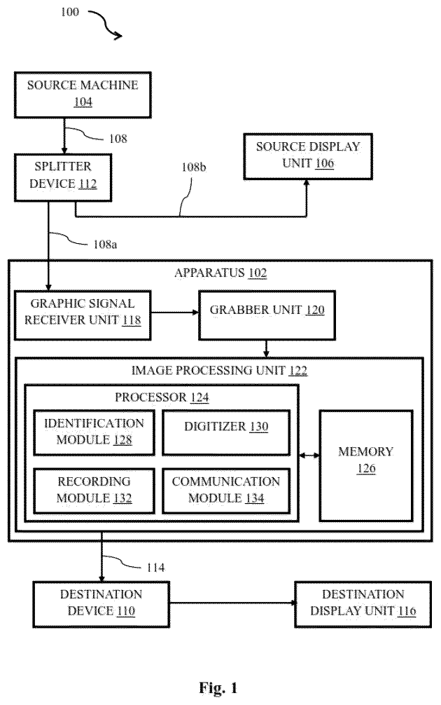

FIG. 1 illustrates a network architecture (100) employing the apparatus (102) for data acquisition in accordance with the present invention. The network as shown, in an exemplary embodiment, includes a source machine (104) having a display (106) to display images received in the form of a graphic signal from the source machine (104), via a graphics signal cable (108). The graphics signal cable (108) can be at least one of a HDMI cable or a VGA cable. The source machine (104) can be at least one of a computer or a PC or a distributed control system (DCS) server unit. The display (106) may display inter alia numeric values that need to be digitized and transmitted to a remote location.

In an embodiment, a signal splitter device (112) is provided to split the graphic signal of the source machine into at least output two signals. The signal splitter device (112) may receive the graphics signal from the source machine (104) via a single input of the cable (108) and outputs at least two graphics signal via at least two output graphics signal cables HDMI1 108a and HDMI2 108b. One of the output graphic signal cable (108a) is connected to the apparatus (102) while the other output graphic signal cable (108b) may be connected to the source display unit (106).

The apparatus (102) is an image data acquisition tool configured to mimic the numeric values displayed on the display unit (106) at regular interval, in a non-invasive manner. The apparatus (102) is an integrated electronic system having multiple inbuilt components like a graphic signal receiver unit (118), a grabber unit (120), an image processing unit (122), along with indigenously designed circuit and machine level code for communicating and processing the instructions. In an embodiment, the apparatus (102) is configured to interact with the destination device (110) via a user interface application.

Further, the graphic signal receiver unit (118) of the apparatus (102) receives the graphic signals from the source machine via the graphic signal cable (108) and provides the same to the grabber unit (120). The grabber unit (120) is configured to capture or extract one or more data images from the received graphic signals at a predefined time interval. The extracted images are then taken up for processing.

In an embodiment, the image processing unit (122) is configured to process the captured one or more data images as received from the grabber unit (120). The image processing unit (122) includes one or more processors (124) and a computer readable medium (126) storing instructions. The image processing unit (122) may further includes one or more modules such an identification module (128), a digitizer (130), a recording module (132) and a communication module (134), which implement designated tasks on execution of one or more instructions stored on the computer readable medium (126) by the one or more processors (124).

In an aspect, the one or more processor(s) (124) may be implemented as one or more microprocessors, microcomputers, microcontrollers, digital signal processors, central processing units, logic circuitries, and/or any devices that manipulate data based on operational instructions. Among other capabilities, the one or more processor(s) (124) are configured to fetch and execute computer-readable instructions stored in a memory (126). The memory (126) may store one or more computer-readable instructions or routines, which may be fetched and executed to carry out the various processing as envisioned in the present invention. The memory (126) may comprise any non-transitory storage device including, for example, volatile memory such as RAM, or non-volatile memory such as EPROM, flash memory, and the like.

The various modules as depicted as part of the apparatus (102) may be implemented as a combination of hardware and programming (for example, programmable instructions) to implement one or more functionalities of the modules. In examples described herein, such combinations of hardware and programming may be implemented in several different ways. For example, the programming for the modules may be processor executable instructions stored on a non-transitory machine-readable storage medium and the hardware for the modules may comprise a processing resource (for example, one or more processors), to execute such instructions. In some examples, the modules may be implemented by an electronic circuitry.

The identification module (128) is configured to identify a location of a numeric value present in each of the captured data images, for example, using a digit recognition technique known in the art, and separate smaller images for each number. The identification module (120) then sends the images for digitisation processing to the digitizer (130). The digitizer (130) extracts the numeric values and digitizes each of the identified numeric values with corresponding time stamps to provide digitized data files. The digitized data files are collected by the recording module (132) at a prescribed time interval. Further, the communication module (134) may communicate the digitized data files to a destination device (110), for example using a cable (114). The format of the digitized data files can be at least one of a *.csv, *.xls, *.txt, *.dat, etc.

In an embodiment, the communication module is implemented as a network based device for collection and/or transmission of the digitized data files to a desired destination device at a remote location.

The destination device (110) can be at least one of a computer, IoT cloud drive, Local Area Network device, Database and an SQL server having graphic processing capability and having a display (116). The destination device (110) is connected to the output of the apparatus (102) using the cable (114), thus interacting with the source machine (104). Following image capturing, digitization of the numbers and generation of data files, the same can be accessed on the destination device (110) as a row of data record for the same point of time along with a time stamp.

In an embodiment, the apparatus (102) comprises an input port to connect with the graphic signal cable (108a) and an output USB port to connect the apparatus (102) with the destination device (110) using a USB data cable (114). The apparatus (102) may be powered independently to run continuously and process the instructions.

The image processing unit (122) may also include modules to detect abnormal data, outliers, bad images, communication errors, etc., in order to avoid junk data or misinterpretation of image to data conversion.

The apparatus (102) according to the present invention is capable providing digital values from a non-invasive system, the non-invasive systems being legacy/secure/locked systems. Further, the apparatus (102) can operate independent of plant OT or IT network and without connecting to the secured IT network or CPU or DCS servers. The apparatus (102) is a real time digitisation tool where processing happens on real time basis and data captured is in the form of time series.

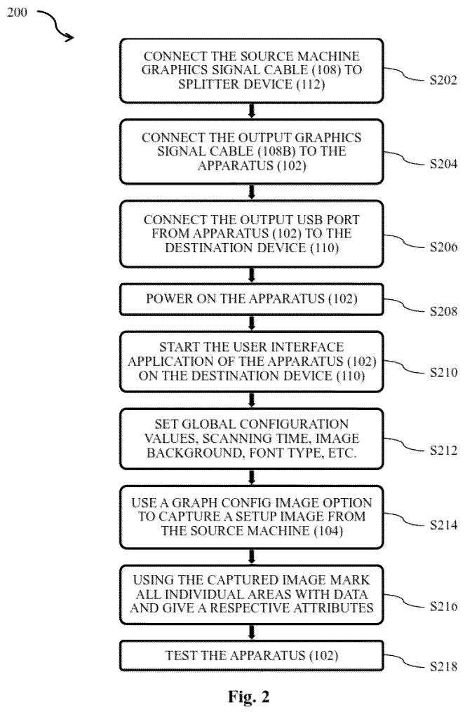

In an embodiment of the present invention, a user interface application is configured on the destination device (110). FIG. 2 illustrates a setup work flow chart (200) for first time run of the user interface application and configuration of the apparatus (102) in accordance with the present invention.
S202: Connect the source machine graphics signal cable (108) to splitter device (112).
S204: Connect the output graphics signal cable (108a) to the apparatus (102).
S206: Connect the Output USB port from apparatus (102) to the destination device (110).
S208: Power ON the apparatus (102).
S210: Start the user interface application of the apparatus (102) on the destination device (110).
S212: Set global configuration values, scanning time, image background, font type, etc.
S214: Use a graph CONFIG image option to capture a SETUP image from the source machine (104).
S216: Using the captured image presented on the CONFIG page, mark all individual areas with DATA with rectangular mouse selection and give a respective attributes such as variable name, minimum and maximum expected value, scanning time, error value, etc.
S218: Test the apparatus (102) with “test configuration” option and accept all good TAGS configuration.

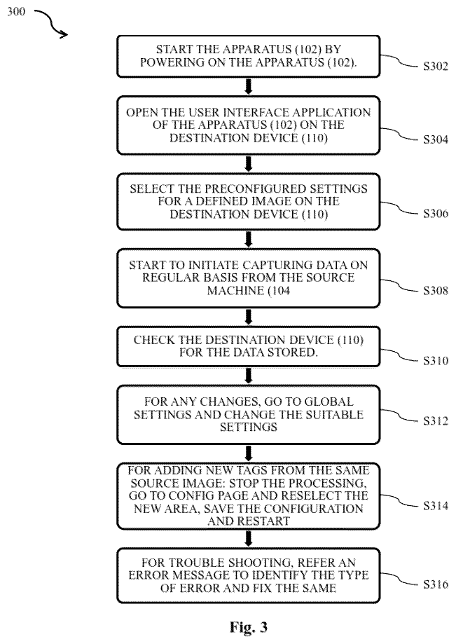

In an embodiment of the present invention, a configured user interface application run on the destination device (110). FIG. 3 illustrates a usage work flow chart (300) for subsequent run of the user interface application of the apparatus (102) in accordance with the present invention.
S302: Start the apparatus (102) by powering ON the apparatus (102).
S304: Open the user interface application of the apparatus (102) on the destination device (110) where the apparatus (102) is connected.
S306: Select the preconfigured settings for a defined image on the destination device (110).
S308: Start to initiate capturing data on regular basis from the source machine (104), mimicking data as displayed on the source display unit (106).
S310: Check the destination device (110) for the data stored.
S312: For any changes in scanning time, output file type, frequency of data writing to destination device (110), error handling options, go to Global settings and change the suitable settings.
S314: For adding new TAGS from the same source image. STOP the processing, go to CONFIG page and reselect the new area and mark the boundary for the same and identify the details. SAVE the configuration and restart the processing of the apparatus (102).
S316: For trouble shooting, refer an error message given on a top right corner of the user interface to identify the type of error, such as a communication error, image quality error, configuration file missing error, destination device related errors etc., and fix the same.

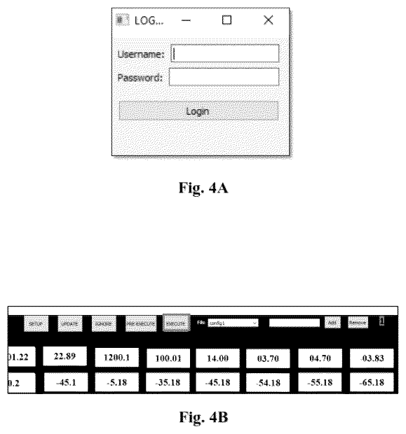

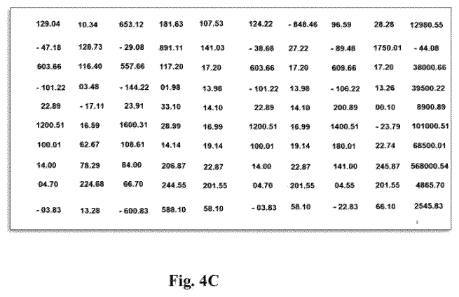

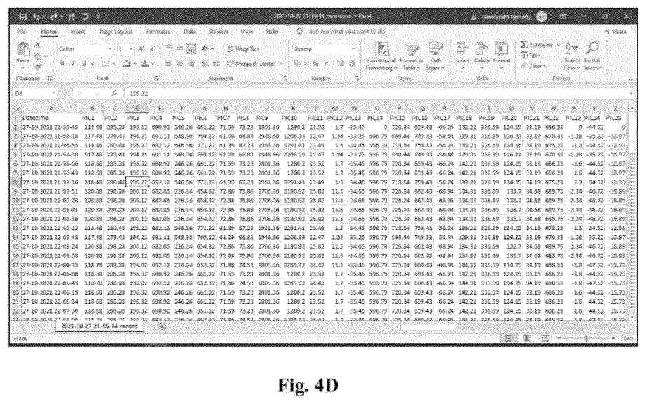

Referring to FIG. 4A, FIG. 4B, FIG. 4C, and FIG. 4D, is shown the user interface if the apparatus (102) device on the destination device (110) at different stages of the process. The apparatus (102) is a secured device and can be accessed after a user has logged in to the user interface of the destination device, as shown in FIG. 4A. After secured login, the user is presented with a CONFIG page as shown in FIG. 4B. If the user is running the user interface for the first time, the user may set global configuration values, scanning time, image background, font type, etc. Further, using a graph CONFIG image option on this page, a user may capture a SETUP image from the source machine (104), which initiates the capturing, by the grabber unit (120), of the one or more data images from the received graphic signals by the graphic signal receiver unit (118) of the apparatus (102). Further, using the captured image presented on the CONFIG page, a user may mark all individual areas with DATA with rectangular mouse selection and give a respective attributes such as variable name, minimum and maximum expected value, scanning time, error value, etc. once configuration is completed, the image processing unit (122) of the apparatus (102) may start the process of the identification, digitization, recording and communication.

For every consecutive run of the user interface on the destination device (110), the user may not have to configure the capturing and may simply start the to initiate capturing data on regular basis from the source machine (104), mimicking data as displayed on the source display unit (106). Further, in consecutive application run, if the user may want to change the configuration, such as, scanning time, output file type, frequency of data writing to destination device (110), error handling options, the user may go to Global settings and change the suitable settings.

FIG. 4C illustrates digitised values of the captured data from the source machine. The identification module (128) identifies a numeric value present in each of the captured data images using a digit recognition technique, and the digitizer digitizes each of the identified numeric values with corresponding time stamps to provide digitized data files.

Referring to FIG. 4D, the digitised values of the captured data as shown in FIG. 4C is now exported into the digitised file format with corresponding time stamps. A recording module (132) of the image processing unit (122) collects the digitized data files, and using communication module (134) the digitised file format as shown in FIG. 4D, is communicated to the destination device (110). Here as an exemplary embodiment the format shown is *.xls, compatible with MS-Excel. Other formats can be at least one of *.csv, *.txt, *.dat, etc.

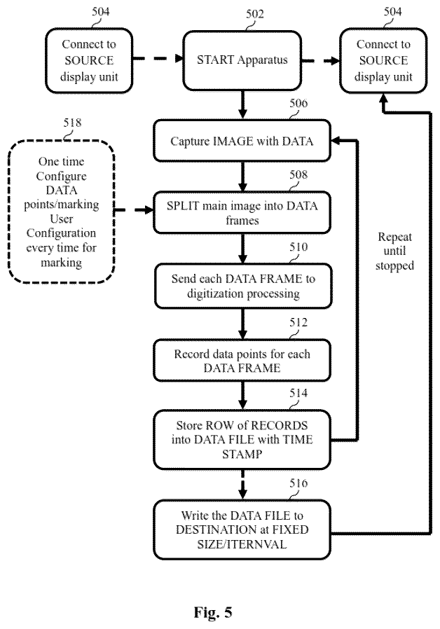

FIG. 5 illustrates the flowchart depicting the correlation between the hardware and user interface aspect of the present user interface working in coordination with one another, in an aspect of the present invention. At step 502, the user interface of the apparatus (102) is run on the destination device (110). At step 506, the apparatus captures the image from the graphic signals sent by the source machine (104) to the source display unit (106). For the first run of the apparatus (102) on the user interface, at step 518, the user interface sets up the apparatus device (102), configures and marks the digital image captured from the source machine for the first time. At step 508 the image data is split into data frames in accordance with the set configuration. At step 510, each DATA FRAME is sent for digitization, as per the configured settings for digitisation, which defines operational settings. Here the digitization processing uses AI algorithm to instruct apparatus device (102) to grab the image on suitable time, process the image, extract pre-marked areas with numbers, run the AI algorithm for recognising the numerical portion. at step 512, data points for each DATA FRAME are recorded and at step 514, data is derived from the images and stored against the marked variable, and generate a time series data for a certain time stamp and complete activity for all the marked numbers on the image. Step 514 is repeated for all the marked numbers and stored as a record for a given time stamp. At step 516, the data is sent or written on an output file or database or any other destination device, at a fixed interval or fixed size. Repeat the task as device. Step 516 is repeated until the apparatus (102) is stopped.

According to the present invention, using the apparatus (102), digital values can be extracted from a non-invasive system such as a distributed control system, which cannot be extracted otherwise. Non-invasive systems being legacy/secure/locked systems. Further, apparatus of the present invention is capable of reading values of a control system display for further processing or later use, without touching or interfering with the existing working of the system. Therefore, the apparatus can be incorporated within an existing industry/continuous process plants where access to secured or locked DCS system is not feasible.

Another advantageous application of the apparatus in accordance with the present invention is the capability to facilitate transfer of data over a network to a remote location for a remote use. Therefore, disclosed apparatus can be incorporated within an existing plant with old generation control system where migration to Smart 4th Gen/IoT technology is not feasible.

Therefore, present invention may revolutionize the industry by enabling the obsolete control systems to be at par with the modern technology in economical manner, and by reducing the scraping of old fully functional and working systems which otherwise have been scraped for their non-capability of extraction of numeric values. Thus enabling a user to build historians with recorded data for unique or customised management information system (MIS), analytics and graphic visualization.

The advantages set forth above, and those made apparent from the foregoing description, are attained in an effective and cost-efficient manner. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. An apparatus for image data acquisition and processing, the apparatus comprising:
a graphic signal receiver unit configured to receive graphic signals from at least one source display unit of a source machine;
a grabber unit configured to capture one or more data images from the received graphic signals at a predefined time interval; and
an image processing unit configured to process the captured one or more data images, the image processing unit including one or more processors and a computer readable medium storing instructions, which instructions, when executed by the one or more processors, perform the steps of:
identifying, by an identification module, a numeric value present in each of the captured data images using a digit recognition technique;
digitizing, by a digitizer, each of the identified numeric values with corresponding time stamps to provide digitized data files;
collecting, by a recording module, the digitized data files; and
communicating, by a communication module, the data files to a destination device.

2. The apparatus for image data acquisition and processing as claimed in claim 1, wherein the apparatus comprises a signal splitter device attached between an output of the source machine and the graphic signal receiver unit, wherein the signal splitter device is configured to split the graphic signal of the source machine to at least two signals and supplying one of the signal to the graphic signal receiver unit.

3. The apparatus for image data acquisition and processing as claimed in claim 1, wherein the source machine is at least one of a source computer, control system and a distributed control system (DCS) server unit.

4. The apparatus for image data acquisition and processing as claimed in claim 1, wherein the destination device is a computer.

5. The apparatus for image data acquisition and processing as claimed in claim 1, wherein the apparatus comprises a network based device for collection and/or transmission of the digitized data files to a destination device at a remote location at a prescribed interval.

6. The apparatus for image data acquisition and processing as claimed in claim 5, wherein the network based device is a communicator selected from at least one of a local intranet server, a cloud resource and a mobile device.

7. A method for image data acquisition and processing, the method comprising:
receiving graphic signals from a source machine;
capturing one or more data images from the received graphic signal;
identifying a numeric value present in each of the captured data images using a digit recognition technique; and
digitising each of the identified numeric values with corresponding time stamps to provide digitized data files;
collecting the digitized data files; and
optionally communicating the data files to a destination device.

8. The method as claimed in claim 7, wherein the method comprises splitting the graphic signal received from the source machine into at least two signals supplying one of the signal to the graphic signal receiver unit.

9. The method as claimed in claim 7, wherein the method comprises collecting data set in digitised format and transmitting the data set in digitised format to the destination device at a prescribed interval.
